(19) United States
(12) Patent Application Publication
(10) Pub. No.: US 2008/0243329 A1
(43) Pub. Date: Oct. 2, 2008

(54) Detection and Compensation of Periodic Disturbances in a Motor Vehicle Steering Device

(76) Inventors: Jorg Hamel, Landau (DE); Frank Peter Engels, Solingen (DE); Torsten Wey, Moers (DE)

Correspondence Address: ANGELA M. BRUNETTI, PLLC, 11300 E. CARIBBEAN LN., SCOTTSDALE, AZ, 85255, US

(21) Appl. No.: 12/057,412

(22) Filed: Mar. 28, 2008

(30) Foreign Application Priority Data
Mar. 30, 2007 (EP) 07105294.8

(51) Int. Cl. G06F 17/14

(52) U.S. Cl. 701/29; 701/36

(57) ABSTRACT

A method and device for the detection and compensation of periodic disturbances in the steering device of a motor vehicle in which a speed-dependent target frequency is determined, and that a Fourier analysis of a time profile of the steering force and/or of the steering torque is carried out for the determined target frequency or a multiple of the target frequency. The method and device also include obtaining amplitudes that are plotted as a function of the vehicle speed, and a model function may be adapted to the curve, the adapted parameter of which model function then constitutes a robust measure for the disturbances. As a function of the parameter, the disturbances can then be suppressed by means of targeted action on a power assistance arrangement of the steering.

### CROSS REFERENCE TO RELATED APPLICATIONS

The inventive subject matter is also described in EP 017105294.8, filed Mar. 30, 2007, whose subject matter is incorporated herein by reference and provides the basis for a claim of priority of invention under 35 U.S.C. §119.

### TECHNICAL FIELD

The inventive subject matter relates to a method and device for the detection of periodic disturbances in the steering device of a motor vehicle having a determination of a speed of the motor vehicle and having a determination of a time profile of a steering force and/or of a steering torque. The inventive subject matter also relates to a method and device for the compensation of the detected periodic disturbances in a motor vehicle having a power-assisted steering device.

### BACKGROUND

In motor vehicles, various periodic disturbances can occur in the steering device, in particular as a result of poorly-balanced front wheels or as a result of thickness variation of the brake disks. Such periodic disturbances are made noticeable at the steering wheel by means of a steering restlessness which is perceived as being uncomfortable to a driver.

Although continuous damping of the disturbances by means of corresponding setting of the power assistance of the steering device can be carried out, this has an adverse effect on the steering feel. Since the disturbances occur cyclically, it is sought to activate an additional damping of the steering system only when a disturbance actually occurs.

JP 2004161073 discloses a method for operating an electromechanically assisted steering device. The method is intended to give the driver feedback regarding unusual oscillations in the steering device. For this purpose, a vehicle speed and a steering torque of the steering device are determined. A frequency spectrum is subsequently generated by means of a high-speed Fourier transformation from the steering torque profile, which frequency spectrum is examined for maximum amplitudes. The maximum amplitudes are utilized for determining a disturbance frequency which is examined by means of an evaluation device for the presence of a disturbance. A disadvantage of the known method is that high-speed Fourier transformations which are to be carried out over a relatively large frequency range are associated with a high level of computing expenditure, so that the microprocessor systems of the vehicle are heavily loaded.

An object of the inventive subject matter is to provide a method for the detection and optionally also for the compensation of periodic disturbances in the steering device of a motor vehicle and to a corresponding device for carrying out the method, which method and device permit robust determination of disturbances in the steering device by means of a low computing capacity.

Other objects and features of the inventive subject matter will become apparent when viewed in light of the detailed descriptions of the embodiments when taken in conjunction with the attached drawings and appended claims.

### SUMMARY

According to the inventive subject matter, periodic disturbances in the steering device are detected to determine a speed-dependent target frequency and to carry out a Fourier analysis of the time profile of the steering force and/or of the steering torque on the basis of the determined target frequency. Here, one or more frequency ranges are not taken into consideration in the Fourier analysis, with the upper and/or lower limit of the frequency range or ranges being dependent on the speed-dependent target frequency. The required computing time or computing capacity is reduced in this way.

The Fourier analysis may be carried out exclusively at the speed-dependent target frequency (1^{st} order) and/or at one or more multiples (higher orders) of the target frequency. This means, for the regions omitted in the Fourier analysis, an example being for the case in which the first and second orders of the target frequency are taken into consideration, the Fourier analysis is not carried out in the range [0, target frequency] and [target frequency, 2* target frequency] and also [2* target frequency, “^{∞}”]. The calculation can be considerably simplified in this way.

The method according to the inventive subject matter permits disturbance detection with comparatively little computing expenditure, so that the method can be implemented in the usual control units for power-assisted steering devices, in particular for electrically assisted steering devices.

The undesired disturbances which are to be detected are caused by periodic force fluctuations in the steering device and are dependent on the rotational speed of the front wheels of the motor vehicle and therefore on the vehicle speed. In order to detect a periodically occurring disturbance, the steering torque is initially determined, in particular by a torque sensor integrated in the steering column of the motor vehicle, or the steering force is initially determined, in particular by means of a steering link force sensor. In addition, the speed of the motor vehicle is determined by means of a corresponding sensor. The target frequency for the Fourier analysis can be calculated on the basis of the determined speed, that is to say from the rotational speed of the front wheels.

In one embodiment, the amplitudes of a time profile of the steering force and/or of a steering torque are determined at the target frequency (or a multiple of the target frequency), and are plotted against the speed of the motor vehicle. A model curve with at least one adaptable parameter may be adapted to the measured values. It is then possible, on the basis of the at least one adapted parameter of the model curve, to draw conclusions regarding the cause of the disturbances and possibly to initiate suitable measures for suppressing the disturbance.

It is thus possible, for example in the event of an unbalance of the front wheels, for an assistance force regulator of the steering device to switch to a parameter set with higher damping preferably only at the times of the cyclically occurring disturbances.

The above-described adaptation process can of course fundamentally also be carried out when a continuous Fourier spectrum has been calculated; in this case, only the amplitudes at the target frequency or at a higher order of the target frequency are then used.

In a further embodiment, it is provided that the Fourier analysis is carried out with the simplification ωτ=2πC v(t)τ≈2πC s(τ) for the two integrands of the equations

$$\begin{matrix}{a}_{k} ( t ) = \frac{2}{T} {\int }_{t - T}^{t} {T}_{c} ( τ ) \cdot cos ( k \cdot ω τ ) d τ and & ( 1 ) \\ {b}_{k} ( t ) = \frac{2}{T} {\int }_{t - T}^{t} {T}_{c} ( τ ) \cdot sin ( k \cdot ω τ ) d τ , & ( 2 )\end{matrix}$$

which are considerably simplified and can therefore be calculated more quickly. The simplification is based on the assumption that the change in the speed of the motor vehicle is significantly less than the change in the steering forces or steering torques caused by the disturbance. Here, ω denotes the angular frequency [1/s], τ denotes the infinitesimal variable, C is the reciprocal wheel circumference of a motor vehicle wheel [1/m], v(t) is the instantaneous speed [m/s] of the motor vehicle, k is the order of the disturbance to be considered, and T_{c}(τ) is the measured instantaneous steering torque [Nm].

In a further embodiment, it is provided that an integration of Fourier coefficients is carried out by means of an approximation according to the trapezoid method, in which a number of nodes N is selected according to the equation N=┌Tₘₐₓ/Tₛ┐=┌1/(C·vₘᵢₙTₛ┐ as a function of the integration time T [s], the sampling interval Tₛ [s] and the maximum integration time Tₘₐₓ [s]. The trapezoid method is an approximation method in which the area below a curve is approximated by means of a plurality of trapezoids arranged below the curve. A fast and only slightly less precise area determination is obtained in this way. By using the trapezoid method, it is therefore possible to obtain a further simplification of the calculations to be carried out for determining the periodic disturbances.

In a further embodiment, it is provided that an approximation of the amplitudes, which are plotted against the speed, from the Fourier analysis is carried out on the basis of a model equation according to

$${\hat{A}}_{k} = {a}_{k} \cdot \sqrt{\frac{{Ω}^{2} ( 1 + 4 {d}_{k}^{2} \cdot {Ω}^{2} )}{{( {Ω}^{2} - 1 )}^{2} + 4 {d}_{k}^{2} \cdot {Ω}^{2}}} \qquad ( 3 )$$

where Ω=v(tᵢ)/vₖ (4) .

It has been proven that the parameters vₖ and dₖ can be predefined to be substantially constant for a certain vehicle type regardless of the disturbance. Here, vₖ describes the speed at which the maximum disturbance occurs; dₖ describes how fast the disturbance decays when departing from the maximum value. The variables are significantly dependent on the dynamic properties of the steering system and are therefore predefinable, vehicle-specific parameters which need not be calculated or determined in some other way but rather can be stored in a value table of the control unit for the steering device.

The remaining parameter aₖ is, according to one advantageous embodiment, determined by means of comparison with the calculated disturbance amplitudes Aₖ (tᵢ) with an LSQ (Least Squares with a Single Quadratic Constraint)estimation algorithm. The LSQ estimation algorithm permits fast determination of the parameter aₖ; in particular because the parameter aₖ is contained only linearly in the above equation (3). It is however alternatively also conceivable to carry out the regression multi-dimensionally and to also determine the non-linear parameters vₖ and/or dₖ from the physical measured values. For the previously-examined disturbances, although the parameters are approximately constant, cases are however entirely conceivable in which one of the other parameters could correlate directly with a disturbance influence.

It is of course also possible for other types of model function to be used.

According to a further aspect of the inventive subject matter, a steering device with power assistance is provided which contains a control unit which is set up to carry out a method. A steering device of the inventive subject matter is capable of identifying periodically/cyclically occurring disturbances with little computing expenditure, and can be set up to periodically vary a damping characteristic for the steering assistance in the same way in order to offer an advantageous compromise of damping of the disturbances and steering system which has otherwise good steering feel.

### BRIEF DESCRIPTION OF THE DRAWINGS

The invention is explained in more detail below on the basis of the drawings, in which:

FIG. 1 shows a spectrogram for periodically occurring disturbances in a steering device;

FIG. 2 shows a plurality of curve profile of calculated and approximated amplitudes of periodically occurring disturbances;

FIG. 3 shows a diagram for explaining calculating operations which are carried out within the context of the method according to the invention; and

FIG. 4 shows a block diagram of a device of the inventive subject matter.

### DESCRIPTION OF THE PREFERRED EMBODIMENTS

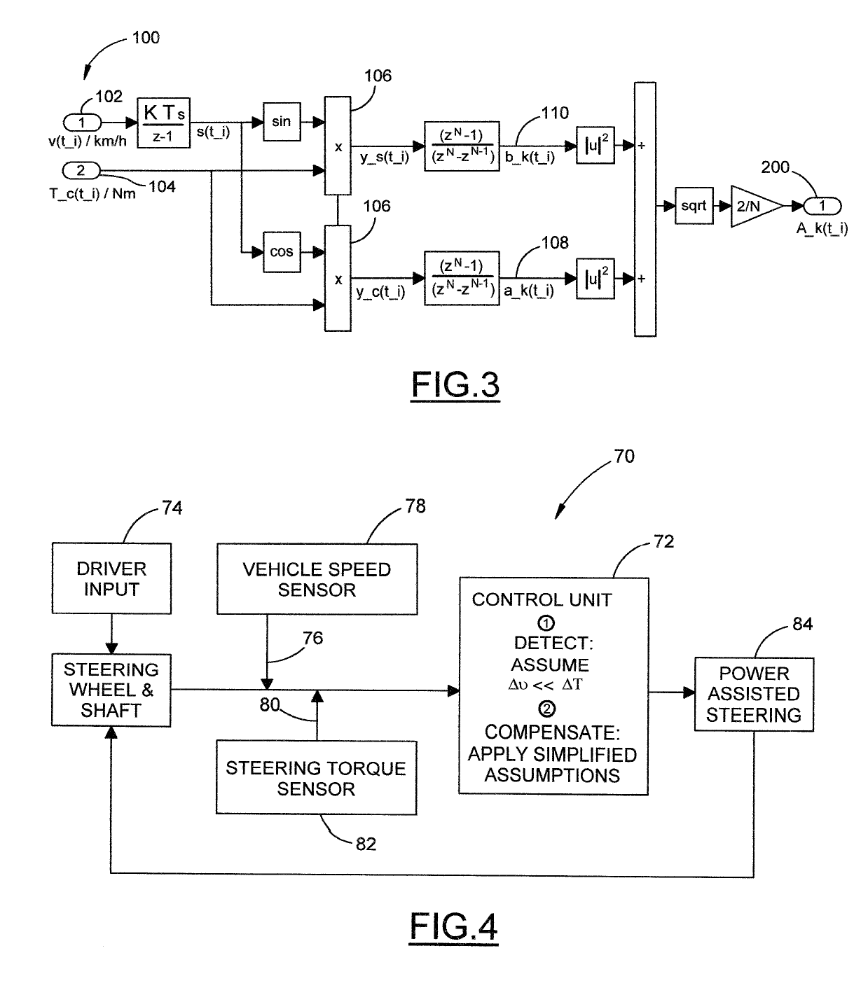

The method 100 for the detection of periodic disturbances in the steering device of a motor vehicle can be divided into two sub-methods with regard to a determination of periodically occurring disturbances, and are shown in block diagram form in FIG. 3. The first sub-method is concerned with the detection of the periodically occurring disturbances. The second sub-method is in contrast concerned with the classification of the occurring disturbances.

For the first sub-method, the speed 102 of the motor vehicle, that is to say the rotational speed of the front wheels (if appropriate by averaging the values of two front wheel individual wheel rotational speed sensors), is initially determined. In a conventional motor vehicle, the front wheels are activated by the steering device and are therefore also closely coupled to the steering wheel of the motor vehicle with regard to the transmission of vibrations. Mechanical deficiencies which are present at the front wheels, such as unbalances or warped brake disks, therefore lead, in driving operation of the motor vehicle, not only to vibrations at the front wheels but also to the coupling of the vibrations into the steering device, in particular into the steering wheel of the motor vehicle.

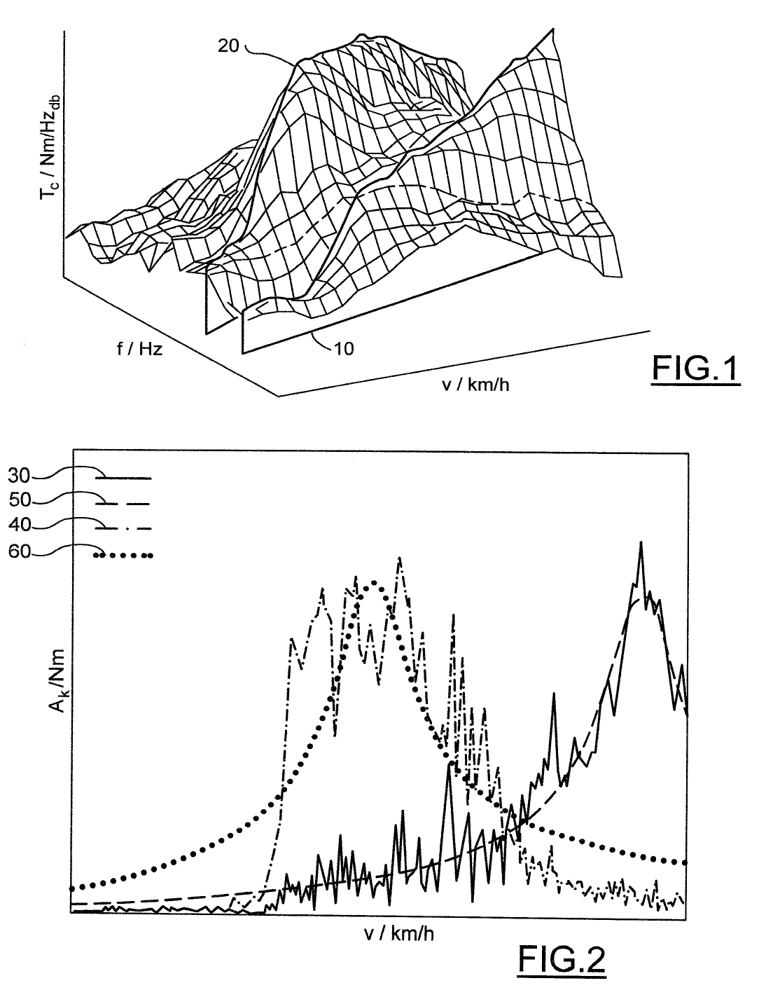

It is therefore possible, on the basis of the rotational speed of the front wheels, to determine the relevant disturbance frequency which can, in the spectrogram illustrated in FIG. 1, be depicted as the straight line 10, or the section plane which proceeds from the latter and is aligned in the vertical direction, for the first order disturbance frequency, or 20 for the second order disturbance frequency, according to the equation:

f=k*C*v [1/s] (5).

Here, f denotes the frequency [1/s], k the order of the disturbance being considered (k=1 . . . n), and C denotes the reciprocal wheel circumference [1/m]. Since the speed v(t) of the motor vehicle varies, the frequency to be determined is time-dependent, which is expressed in the equation

f(t)=C·v(t) (6).

For the frequency f(t), the amplitude of the disturbance is determined from the measured torque 104 T_{c}(t) [Nm]. For the amplitude determination, the Fourier coefficients are firstly determined on the basis of the equations

$$\begin{matrix}{a}_{k} ( t ) = \frac{2}{T} {\int }_{t - T}^{t} {T}_{c} ( τ ) \cdot cos ( k \cdot ω τ ) d τ \\ and & ( 7 ) \\ {b}_{k} ( t ) = \frac{2}{T} {\int }_{t - T}^{t} {T}_{c} ( τ ) \cdot sin ( k \cdot ω τ ) d τ . & ( 8 )\end{matrix}$$

In order to ensure faster determination of the Fourier coefficients, it is assumed that the change in the speed of the motor vehicle is significantly smaller than the change in the steering forces or steering torques caused by the disturbance. The assumptions are represented in FIG. 3 as 106. Under this assumption, the integrand in the above integrals (7/8) can be modified as follows:

ωτ=2πC v(t)τ≈2πC s(τ) (9)

where ω is the angular frequency [1/s], τ is the infinitesimal variable, C is the reciprocal wheel circumference of a motor vehicle wheel [1/m] and v(t) is the instantaneous speed [m/s] of the motor vehicle.

The mean distance s(τ) [m] per measurement time section Tₛ [s] can then be expressed with the equation

$$s ( {t}_{i} ) \approx s ( {t}_{i - 1} ) + {T}_{s} \frac{v ( {t}_{i} ) + v ( {t}_{i - 1} )}{2} , \qquad ( 10 )$$

from which, with the equation

y_{c}(tᵢ)=T_{c}(tᵢ)cos(k2πC s(tᵢ)) (11),

the first coefficient 108 of the Fourier analysis can be approximated as follows:

$${a}_{k} ( {t}_{i} ) \approx \frac{2}{N} ( \frac{{y}_{c} ( {t}_{i} )}{2} + {\sum }_{j = 1}^{N - 1} {y}_{c} ( {t}_{i - j} ) + \frac{{y}_{c} ( {t}_{i - N} )}{2} ) . \qquad ( 12 )$$

For the second Fourier coefficients 110, the corresponding equations:

yₛ(tᵢ)=T_{c}(tᵢ)·sin(k2πC s(tᵢ)) (13)

$${b}_{k} ( {t}_{i} ) \approx \frac{2}{N} ( \frac{{y}_{s} ( {t}_{i} )}{2} + {\sum }_{j = 1}^{N - 1} {y}_{s} ( {t}_{i - j} ) + \frac{{y}_{s} ( {t}_{i - N} )}{2} ) \qquad ( 14 )$$

are utilized.

The integration is carried out by means of the trapezoid rule with a fixed number of N nodes. The number of nodes N is determined as follows:

N=┌Tₘₐₓ/Tₛ┐=┌1/(C·vₘᵢₙTₛ)┐ (15)

where:
Integration time T=1/ƒ=1/(C·v(t)) [s]
Sampling interval Tₛ [s]
Maximum integration time Tₘₐₓ=1/(C·vₘᵢₙ) [s]
vₘᵢₙ=minimum speed for which disturbances are still to be detected [m/s]

From the above equations, it is now possible to calculate the k-th order amplitude of the disturbance for the corresponding frequency:

Aₖ(tᵢ)=\sqrt{|aₖ(tᵢ)|²|bₖ(tᵢ)|²}

The approximations have the effect that the multiplication can be carried out, with sine and cosine, virtually in advance, with the present frequency; one therefore need calculate only one cosine and one sine function for one time step. Without this approximation, it would be necessary at each time step to calculate the cosine and sine function for all the preceding frequency values. By means of the above-stated approximations, it is typically possible to reduce the computing expenditure by a factor of one hundred with respect to a complete Fourier analysis.

The first-order and second-order amplitudes are plotted in FIG. 2 as lines 30 and 40.

FIG. 3 shows a possible implementation of the calculation guidelines as per equations 10 to 14, 15 and 16 in a Simulink illustration (Simulink is a registered trademark of The MathWorks, Inc., Natick, Mass., USA).

Subsequent to the calculation of the amplitudes, within the context of a second sub-method 200, an approximation of the speed-dependent amplitude profile of the disturbance takes place on the basis of a suitable approximation or model equation, for example with:

Ω=v(tᵢ)/vₖ (17)

$${\hat{A}}_{k} = {a}_{k} \cdot \sqrt{\frac{{Ω}^{2} ( 1 + 4 {d}_{k}^{2} \cdot {Ω}^{2} )}{{( {Ω}^{2} - 1 )}^{2} + 4 {d}_{k}^{2} \cdot {Ω}^{2}}} \qquad ( 18 )$$

where vₖ describes the speed at which the maximum disturbance occurs (vehicle-specific, but constant); dₖ describes how fast the disturbance decays when departing from the maximum value (vehicle-specific, but constant) and aₖ is determined from the disturbance amplitude Aₖ(tᵢ) as per equation 16. Model curves for the approximation of the first-order and second-order amplitudes are plotted as lines 50 and 60 in FIG. 2.

If for example only the first order of the disturbance is considered, then the parameter a₁ of the above model equation correlates linearly with the unbalance at a front wheel, so that the disturbance can be seen directly in a₁.

The above-described method differs from other order analyses in which a plurality of values of the time domain are transformed into a plurality of values of the frequency domain in that, for each new measured input value, a new value is delivered at the output. This is based substantially on the following simplified assumptions: p0 a) The assumption of a vehicle speed which changes slowly compared with the disturbance delivers sufficiently precise results;
b) The dependency on the vehicle speed can be converted into a position dependency;
c) The integration over a fixed time is sufficiently precise.

The approximations reduce the computing expenditure considerably and therefore permit the calculation on current control computers in real-time, with the computing expenditure of a Fast Fourier Transformation (FFT) being avoided.

One advantage of the above-described method is that the algorithm can, at each time step, deliver a new (improved) estimation for the amplitude and model parameters.

It is additionally advantageous that, as a result of the amplitudes of the disturbance being taken into consideration only in relation to the vehicle speed (along a straight line), a more robust calculation is given than in other solutions in which a fixed frequency band is considered.

It is additionally advantageous that, by means of the additional classification of the disturbance on the basis of a model equation which is characteristic for the vehicle and disturbance, the detection is very robust with respect to parameter or environmental influences.

The device is shown 70 in FIG. 4. Control unit 72 is coupled to the steering wheel and shaft that is subject to a driver (vehicle operator) input 74. The control unit 72 receives a vehicle speed signal 76 from a vehicle speed sensor 78 and a steering torque signal 80 from a steering torque sensor 82. The control unit 72 implements the first sub-method as described above with reference to FIG. 3 to detect the periodic disturbances which is expedited by applying the assumption that the change in the speed of the motor vehicle is significantly smaller than the change in the steering forces or steering torques caused by the disturbance. The control unit 72 implements the classification, or compensation, of the periodic disturbances by applying the second sub-method, described above with reference to FIG. 3. The second sub-method application being expedited within the control unit 72 by applying the assumptions that:
a) a vehicle speed which changes slowly compared with the disturbance delivers sufficiently precise results;
b) the dependency on the vehicle speed can be converted into a position dependency; and
c) the integration over a fixed time is sufficiently precise.
   The assumptions for sub-method 1 and sub-method 2 simplify the computing capacity required and therefore, control unit 72 is capable of determining any disturbance of the steering device and compensating for the disturbance in a power assisted steering device 84.

While particular embodiments of the invention have been shown and described, numerous variations and alternative embodiments will occur to those skilled in the art. Accordingly, it is intended that the invention be limited only in terms of the appended claims.

What is claimed is:

1. A method for detecting periodic disturbances in a steering device of a motor vehicle, the method comprising the steps of:
determining a speed of the motor vehicle;
determining a time profile of a steering force, a steering torque or a steering force and a steering torque;
determining a speed-dependent target frequency which preferably corresponds to the speed of the motor vehicle;
carrying out a Fourier analysis of the time profile of the steering force, the steering torque, or the steering force and the steering torque with one or more frequency ranges being excluded from consideration in the Fourier analysis, the one or more frequency ranges having an upper limit and a lower limit being dependent on the speed-dependent target frequency; and
detecting periodic disturbances in the steering device as a function at least of the Fourier analyses carried out.

2. The method as claimed in claim 1, wherein the step of carrying out the Fourier analysis further comprises taking only the first order of the target frequency and one or more higher orders of the target frequency into consideration.

3. The method as claimed in claim 2, wherein the step of detecting periodic disturbances further comprises evaluating amplitudes obtained from a plurality of Fourier analyses at different vehicle speeds.

4. The method as claimed in claim 3, wherein the step of detecting periodic disturbances further comprises:
providing at least one speed-dependent model equation having at least one adaptable parameter, the at least one adaptable parameter being adapted by means of a regression method to the amplitudes, which are plotted as a function of the speed, from the Fourier analysis for a predefined order, and the extent and the type of periodic disturbance are determined as a function of the at least one adapted parameter.

5. The method as claimed in claim 4, wherein the step of carrying out the Fourier analysis further comprises the simplification, ωτ=2πC v(t)τ≈2πC s(τ).

6. The method as claimed in claim 5, further comprising the step of:
integrating Fourier coefficients by means of an approximation according to a trapezoid method, in which a number of nodes N is selected as a function of an integration time T [s], a sampling interval Tₛ [s] and a maximum integration time Tₘₐₓ [s].

7. The method as claimed in claim 6, further comprising the step of:
adapting the amplitudes, which are plotted against the speed, from the Fourier analysis carried out on the basis of a model equation according to:
$${\hat{A}}_{k} = {a}_{k} \cdot \sqrt{\frac{{Ω}^{2} ( 1 + 4 {d}_{k}^{2} \cdot {Ω}^{2} )}{{( {Ω}^{2} - 1 )}^{2} + 4 {d}_{k}^{2} \cdot {Ω}^{2}}} ,$$
where Ω=v(tᵢ)/vₖ.

8. The method as claimed in claim 7, wherein the parameters vₖ and dₖ are predefined, vehicle-specific parameters, and further comprising the step of:
determining a parameter ak from an adaptation of the model equation to the amplitudes Aₖ (tᵢ) determined in the Fourier analysis according to a least square errors method.

9. A method for the compensation of periodic disturbances in a power-assisted steering device of a motor vehicle comprising the steps of:
determining a speed of the motor vehicle;
determining a time profile of a steering force, a steering torque or a steering force and a steering torque;
determining a speed-dependent target frequency which preferably corresponds to the speed of the motor vehicle;
carrying out a Fourier analysis of the time profile of the steering force, the steering torque, or the steering force and the steering torque with one or more frequency ranges being excluded from consideration in the Fourier analysis, the one or more frequency ranges having an upper limit and a lower limit being dependent on the speed-dependent target frequency;
detecting a periodic disturbance in the steering device as a function of the Fourier analyses; and
adjusting the power assistance of the steering device as a function of the detected periodic disturbance to compensate for the detected periodic disturbance latter.

10. A motor vehicle steering device with power assistance comprising:
a control unit adapted to;
determine a speed of the motor vehicle;
determine a time profile of a steering force, a steering torque, or a steering force and a steering torque;
determine a speed-dependent target frequency that corresponds to the speed of the motor vehicle;
carry out Fourier analyses of the time profile for at least one frequency range being excluded from the Fourier analysis; and
detect periodic disturbances in the steering device as a function of the Fourier analyses.

11. The method as claimed in claim 9, wherein the step of carrying out the Fourier analysis further comprises taking only the first order of the target frequency and one or more higher orders of the target frequency into consideration.

12. The method as claimed in claim 11, wherein the step of detecting periodic disturbances further comprises evaluating amplitudes obtained from a plurality of Fourier analyses at different vehicle speeds.

13. The method as claimed in claim 12 wherein the step of detecting periodic disturbances further comprises;
providing at least one speed-dependent model equation having at least one adaptable parameter, the at least one adaptable parameter being adapted by means of a regression method to the amplitudes, which are plotted as a function of the speed, from the Fourier analysis for a predefined order, and the extent and the type of periodic disturbance are determined as a function of the at least one adapted parameter.

14. The method as claimed in claim 13, wherein the step of carrying out the Fourier analysis further comprises the simplification; ωτ=2πC v(t)τ≈2τC s(τ).

15. The method as claimed in claim 14, further comprising the step of:
integrating Fourier coefficients by means of an approximation according to a trapezoid method, in which a number of nodes N is selected as a function of an integration time T [s], a sampling interval Tₛ [s] and a maximum integration time Tₘₐₓ [s].

16. The method as claimed in claim 15, further comprising the step of:
adapting the amplitudes, which are plotted against the speed, from the Fourier analysis carried out on the basis of a model equation according to;
$${\hat{A}}_{k} = {a}_{k} \cdot \sqrt{\frac{{Ω}^{2} ( 1 + 4 {d}_{k}^{2} \cdot {Ω}^{2} )}{{( {Ω}^{2} - 1 )}^{2} + 4 {d}_{k}^{2} \cdot {Ω}^{2}}} ,$$
where Ω=v(tᵢ)/vₖ.

17. The method as claimed in claim 16, wherein the parameters vₖ and dₖ are predefined vehicle-specific parameters, and further comprising the step of determining a parameter aₖ from an adaptation of the model equation to the amplitudes Aₖ (tᵢ) determined in the Fourier analysis according to a least square errors method.

18. The device as claimed in claim 10 wherein the Fourier analyses further comprises taking only a first order of the target frequency and one or more higher orders of the target frequency into consideration.

19. The device as claimed in claim 18, wherein the detection of periodic disturbances further comprises the control unit evaluating amplitudes obtained from a plurality of Fourier analyses at different vehicle speeds.

20. The device as claimed in claim 19 wherein the detection of periodic disturbances further comprises the control unit providing at least one speed-dependent model equation having at least one adaptable parameter, the at least one adaptable parameter being adapted by means of a regression method to the amplitudes, which are plotted as a function of the speed, from the Fourier analyses for a predefined order, and the extent and the type of periodic disturbance are determined as a function of the at least one adapted parameter.

21. The device as claimed in claim 20, wherein the Fourier analyses further comprise the simplification, ωτ=2πC v(t)τ≈2πC s(τ).

22. The device as claimed in claim 21 further comprises the control unit integrating Fourier coefficients by an approximation according to a trapezoid method, in which a number of nodes N is selected as a function of an integration time T [s], a sampling interval Tₛ [s] and a maximum integration time Tₘₐₓ [s].

23. The device as claimed in claim 22, further comprising the control unit adapting amplitudes, which are plotted against the speed, from the Fourier analyses carried out on the basis of a model equation according to;
$${\hat{A}}_{k} = {a}_{k} \cdot \sqrt{\frac{{Ω}^{2} ( 1 + 4 {d}_{k}^{2} \cdot {Ω}^{2} )}{{( {Ω}^{2} - 1 )}^{2} + 4 {d}_{k}^{2} \cdot {Ω}^{2}}} ,$$
where Ω=v(tᵢ)/vₖ.

24. The device as claimed in claim 23, wherein the parameters vₖ and dₖ are predefined vehicle-specific parameters and the control unit determines a parameter ak from an adaptation of the model equation to the amplitudes Aₖ (tᵢ) determined in the Fourier analysis according to a least square errors method.

25. The device as claimed in claim 10 further comprising:
the control unit detecting a periodic disturbance in the steering device as a function of the Fourier analyses; and
the control unit adjusting the power assistance of the steering device as a function of the detected periodic disturbance to compensate for the detected periodic disturbance.
